(19) United States
(12) Patent Application Publication
(10) Pub. No.: US 2005/0005508 A1
(43) Pub. Date: Jan. 13, 2005

(54) Environmentally safe fire starter

(76) Inventor: Thomas Michael Hayden, Portland, OR (US)

Correspondence Address: THOMAS M HAYDEN, 2341 S.E. LADD AVE., PORTLAND, OR, 97214, US

(21) Appl. No.: 10/816,477

(22) Filed: Apr. 2, 2004

Related U.S. Application Data
(60) Provisional application No. 60/469,143, filed on May 12, 2003.

(51) Int. Cl. C10L 11/00; B05D 3/00

(52) U.S. Cl. 44/545; 427/398.1

(57) ABSTRACT

Ever-lite, a non-toxic fire starter is made from a 4×8 piece of pressed wood fiberboard with alum and cornstarch as binders and made from soft wood, preferably a sycamore fiber, with no creosote. It's then cut into 6″×l/2″ pieces and dipped into a p-128 (p-2391) paraffin solution at a temperature between 166 and 170 degrees for one second then cooled down. Ever-Lite burns for approximately 7-10 minutes at 35,000 BTU's. The emissions are non-toxic and are safe around children, food, and animals. It can be lit when wet and stay lit in wind or rain. The stick can be extinguished by depriving it of oxygen. Ever-Lite has an indefinite shelf life, will not become unstable, nor flare up, spark, secrete resins or pitch. Ever-Lite is expected to meet the SCAQMD COS standards of California as well as rule 1174.

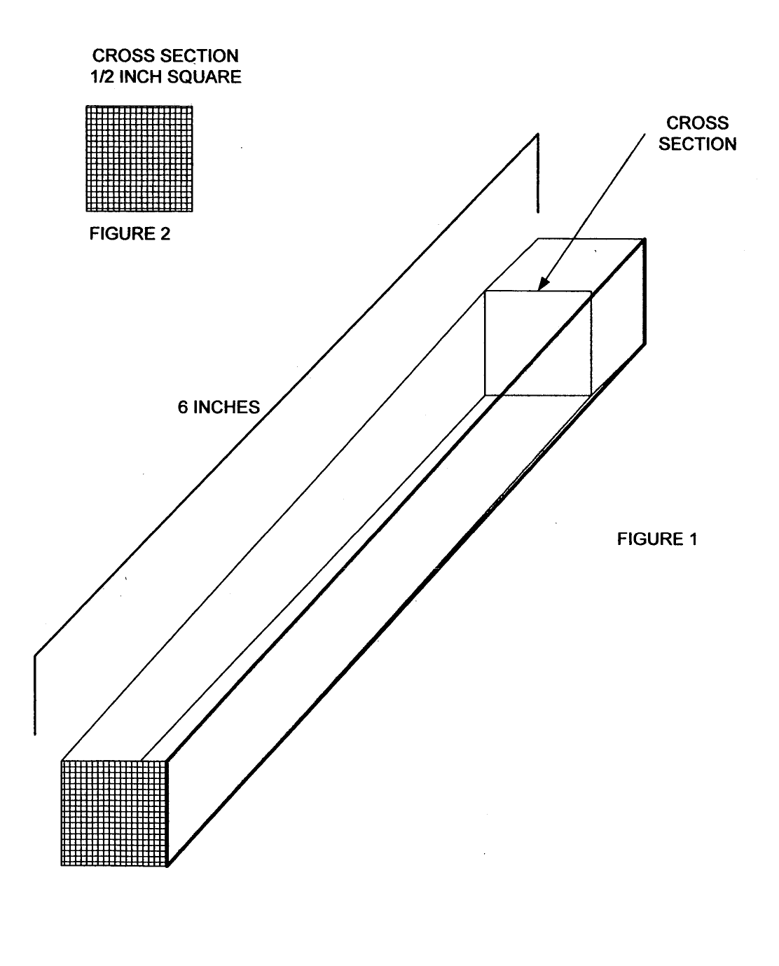

### BACKGROUND OF THE INVENTION

This invention pertains to kindling and more particularly to chemically treated kindling and a process for the production of a fire starter.

Currently, various types of fire starters are available for use in starting fires for home fireplaces, charcoal grills, and campfires, ECT. Some of these fire starters are suitable for starting fires if there is no wind or gusts, or if the material to be burned, for example, wood or charcoal briquettes, is dry or has been recently cut to purchase, respectively. If such is the case, other users generally are required to apply a liquid flammable such as kerosene or charcoal lighter fluid in aiding the ignition of the fire starter to start the fire. Obviously, these particular fire starters are undesirable for outside use in starting a fire in windy wet conditions or if the material to be burned is wet or relatively old. In addition, the necessity of having to use a flammable liquid presents a hazard to the user and those around them.

Generally, fire starters are made of a combustible material coated or saturated with one or a combination of various substances; rosin, tallow, varnish, turpentine, and others. These fire starters may not only burn too rapidly to start a fire, but some are toxic, thereby rendering them a potential hazard to small children and animals. The fire starters also possess a distinct smell or odor, either before or during burning. This odor leaves an undesirable smell or may leave a peculiar taste to the food cooked by the fire starter.

Other fire starters, besides being coated or saturated with the above or similar substances, are coated on their outer surfaces with sawdust or like materials to increase their kindling characteristics. However, these loose coating of sawdust and like materials are messy. They generally do not remain adhered to the outer surface of the fire starter, which diminishes their fire starting capability.

Further undesirable characteristics associated with other fire starters are that they are designed to ignite quickly and burn rapidly. This is only satisfactory in no wind conditions, or with combustible material that is dry. Should wind conditions exist or the combustible material is wet or otherwise hard to burn, a large volume of fire kindler is required to begin the fire. In addition, some fire kindlers require an aid in assisting their ignition, such as a wick or other types of lighting aid.

Another disadvantage of current fire starters, particularly when the fire is intended to be started outside in adverse weather conditions, is that they will not light or stay lit when wet from rain or snow. This is an undesirable feature for outdoor campers, ice fishermen, hunters, climbers, and other outdoor activists.

Attempts have been made to increase other fire starter characteristics, particularly for use in outdoor adverse weather conditions. One such attempt is to coat or saturate the fire starter with a flammable material or substance which will, upon being heated, drip and fall on the combustible material to be burned and on the bottom surface of the container containing the combustible material, for example, the bottom of a charcoal grill. The drippings then ignite to assist in starting the fire.

A particularly disadvantageous feature associated with fire kindlers utilizing dripping of flammable materials is that some of the drippings may not ignite during the existence of the fire, but will then pose a potential fire hazard and leave toxic residues later on. This is especially hazardous if some of the drippings should fall on clothing or other objects or equipment. In view of the above disadvantages, it is clear that there still exists a need for improved fire starters.

### SUMMARY OF THE INVENTION

This invention overcomes the disadvantages of prior fire kindling by providing an improved fire starter and is a process for the production thereof.

The kindling of the invention is saturated with a unique composition, which renders the fire starter not only inoffensive to smell and non-toxic, but also easily lit in various adverse weather conditions. The kindling of the invention is easily lit and remains lit in both rainy and windy conditions. Additionally, if wet the fire starter is easily relit for subsequent use.

Further, due to the unique composition with which the kindling is saturated, the fire starter burns at a controlled rate and requires no other means in assisting its ignition, for example a wick or the like, and will ignite not only along its edge portions but also its flat surface areas. Further desirable features of the fire starter invention is that the composition does not and is not intended to drip while burning, but rather burns to a biodegradable ash. Shelf life of the fire starter is indefinite since the composition with which it is saturated does not readily decompose and is non-toxic.

The fire starter is intended to be used in starting camp fires, fires in home fireplaces, barbecues, pellet stoves, wood burning stoves, survival kits, and as flares. The uses enumerated are intended to be exemplary only and not limitative to the present invention.

In one form of the invention, there is provided an improved fire kindling comprising a combustible material saturated with the unique composition of refined petroleum wax and refined oil. The process for producing the fire kindling of the invention comprises the steps of providing two compositions, each comprising specific and different amounts of refined petroleum wax and refined oil from the others. The two compositions are heated to melted liquid states and then mixed together to form a mixture thereof. Thereafter, the melted mixed compositions are blended to form the final composition, then the fire starter is immersed in the final composition, Thereafter, the step of cooling the removed fire starter of this invention to an ambient temperature.

### DESCRIPTION OF THE DRAWING

The composition of the fire starter stick is as follows. The fire starter comes in a 4 ft×8 ft×1/2 inch sheet of pressed wood board consisting of 92% wood fibers, preferably a soft wood fiber like pine, cedar or sycamore. 4% cornstarch and 4% alum. This 4′×8′ sheet is then cut into 6-inch strips and again cut into 1/2 inch strips using a gang saw. This way of making the fire starter is done to give the fire starter better penetration areas on the sides and ends. The fire starter is then immersed in a blended liquid for 1 second. By forming a fire starter of pressed fiber wood materials, it is generally more porous than solid wood and is therefore more easily saturated, as disclosed hereafter. The cornstarch and alum aid in maintaining the shape rigidity of the fire starter and the saturated composition therein retained. It is to be understood that these percentages are not limitative.

### THE COMPONENTS OF THE FIRE STARTER

The chemical composition with which the fire starter is dipped in is a mixture of five chemically different compounds. In the following description of the five compounds, the percentages given are to be understood to be of weight percentages based on total weight of each individual compound.

The composition of the first compound is about 95% refined petroleum wax and about 5% refined oil and contains a trace amount of butylated hydroxyl toluene (BHT) as an antioxidant. During the burning of the fire starter, it provides increased heat energy. The physical characteristics of compound one are:

| Melting point | 94° F. |
|---|---|
| Specific gravity | 0.81 |
| Flash point | 390° F. |
| Oil content | 0.05 |

The second compound is about 72% refined petroleum wax and 28% refined oil. During the burning of the fire starter, this compound helps to increase the heat energy. The physical characteristics of compound two are:

| | |
|---|---|
| Melting point | 125° F. |
| Specific gravity | 0.847 |
| Flash point | 420° F. |

The third compound is about 87% refined petroleum wax and about 13% refined oil and helps the fire starter to burn in the rain or wet conditions. The physical characteristics of compound three are:

| | |
|---|---|
| Melting point | 128° F. |
| Flash point | 400° F. |

The fourth compound is about 80% refined petroleum wax and about 20% refined oil. This compound helps control the burning rate of the fire starter. The physical characteristics of compound four are:

| | |
|---|---|
| Melting point | 132° F. |
| Flash point | 435° F. |

The fifth and most important compound is 99% refined petroleum wax and about 1% refined oil and contains not more than 15 parts per million of food grade dibutylparacresol as an antioxidant, which inhibits oxidation. The physical characteristics of compound five are:

| | |
|---|---|
| Boiling point | above 600° F. |
| Vapor pressure | less than 0.1 mm Hg at 100° F. |
| Specific gravity | 0.82-0.84 |
| Flash point | 410° F. |
| Melting point | 139° F. |

The different characteristics provided by the five compounds allow the fire starter the capability of being easily lit and burn in windy and wet conditions, increased burn time, a high consistent burn temperature, an even burn on the fire starter, and a high flash point for safety. The five compounds satisfy the standards of 21 CFR, Food and Drug Administration. For example, the refined petroleum wax is a mixture of solid hydrocarbons and paraffin in nature derived from a petroleum; such as distilling Pennsylvania crude refining to meet the specifications in 21 CFR 172.886 and 21 CFR 178.362.

The process in making and producing the fire starter is as follows. The compounds are mixed thoroughly in a temperature range from between 166° F. to 170° F. until all compounds are melted throughly. Throughout the process, all of the compounds are continually mixed within the temperature range. The percentages of weight of the final composition is

| | |
|---|---|
| Compound one | 8% |
| Compound two | 12% |
| Compound three | 17% |
| Compound four | 25% |
| Compound five | 38% |

After the compounds have been mixed, melted and blended together for appoximatly 5 minutes, the fire starter is dipped for 1 second, removed from the dip and cooled before packaging as the final product. Because of the composition of the fire starter, the saturation of the fire starter is complete in the one-second dip. The preferred shape of the fire starter is of a length of 6 inches and 1/2 inch square, for the best results and full saturation on the surface and through the interior.

The described fire starter is easily lit by applying a flame along its edges, surfaces or ends, and no other means are needed to assist in the lighting thereof. While burning, the fire starter produces high-energy output (approx. 35,000 BTU's), burns to a biodegradable ash and has no dripping while burning. The fire starter burns at a controlled rate for about 7 to 10 minutes for each fire starter, with the dimensions of 6 inches by 1/2 inch by 1/2 inch.

The fire starter is virtually odorless when burning and will continue to burn in the windy and gusty conditions and when wet and in the rain. The fire starter itself is easily extinguished by just blowing it out or immersing in water (Removing oxygen).

The fire starter has many uses such as; home fireplaces, barbecues, campfires, survival kits, pellet stoves, flares, to name a few. The fire starter has an indefinite shelf life, due to the fact that the compositions do not readily decompose over an extended period.

While this invention has been described as having a preferred uses, make up and ingredients it should be understood that there may be capabilities of further modifications. This application is therefore intended to cover the fire starter described herein.

1. The process for producing a chemically treated or impregnated kindling for starting fires comprises the following steps using different chemical compositions by weight; refined petroleum wax, refined oil and trace amounts of other chemical compositions. The first composition consists of essentially about 95% refined wax. About 5% refined oil and a trace amount of butylated hydroxyl toluene (BHT) as an antioxidant. The second composition consists of about 72% refined petroleum wax and 28% refined oil. The third composition consists of about 87% refined petroleum wax and 13% refined oil. The fourth composition consists of about 80% refined petroleum wax and 20% refined oil. The fifth and most important composition is 99% refined petroleum wax, about 1% refined oil and contains not more than 15 parts per million of food grade dibutylparacresol as an antioxidant which inhibits oxidation.

2. The percentage in the process in claim 1 by weight of the compositions are essentially 8% of composition one, 12% of composition two, 17% of composition three, 25% of composition four and 38% of composition five

3. Process from claim 2 is mixing and heating all compositions together in a temperature range from 166 degrees F. to 170 degrees F. Once all are fully melted and mixed, wait 5 minutes before immersion.

4. The process in claim 3 is to maintain a temperature range of 166 to 170 degrees F. during operations.

5. In the process of claim 4 is the step of immersion, which includes saturating the kindling in the blended composition for 1 second and the step of cooling the removed kindling to an ambient temperature.

6. The results are a chemically treated kindling produced in accordance with the claim 1 and 2.

7. A chemically treated combustible kindling compromising a composition material saturated and prepared in the claim 1 and 2.

8. The chemically treated kindling of claim 7 percentages by weight of such composition based on the total weight thereof are as stipulated in claim 2.

9. The kindling of claim 5 thru 8 is of a combustible material of a pressed mixture of wood fiber, alum, and cornstarch.

10. The pressed material in claim 9 based on the total weight is about 92% wood fiber, about 4% alum and about 4% cornstarch
